(19) United States
(12) Patent Application Publication
(10) Pub. No.: US 2005/0002183 A1
(43) Pub. Date: Jan. 6, 2005

(54) Driveway and landscape light with survivability and durability attributes

(76) Inventor: Robert W. Wardzala, Belvidere, IL (US)

Correspondence Address: ROBERT W WARDZALA, 853 SPRING RIDGE CT., BELVIDERE, IL, 61008, US

(21) Appl. No.: 10/842,931

(22) Filed: May 11, 2004

Related U.S. Application Data
(60) Provisional application No. 60/469,702, filed on May 12, 2003.

(51) Int. Cl. F21S 8/00

(52) U.S. Cl. 362/145

(57) ABSTRACT

An illumination device comprised of a plurality of discrete light sources (1), a durable housing body (2), a flexible mechanism (3) that provides for survivability due to impact and return to normal position, a support (4) for easy installation, and wiring (5) that permits any number of these units to be easily connected and operated in parallel. A first embodiment utilizes a stake and spring for fixing the unit into the ground. A second embodiment utilizes a breakaway coupling that permits easy replacement of the housing body (2) on the support (4) after accidental upset. Further embodiments can utilize or incorporate infrared emitting diodes as part of monitoring, detection, and other security systems. In all embodiments, the diodes may be arranged for uniform coverage or sector coverage depending on the type of application such as for driveway, walkway, or landscape illumination. Low power consumption and long life are additional features.

### CROSS-REFERENCE TO RELATED APPLICATIONS

Applicant claims benefit of Provisional Patent Application No. 60/469,702 filed on May 12, 2003 and Titled: Driveway and landscape light with durability and survivability attributes.

### BACKGROUND

1. Field of Invention

This invention relates to outdoor landscape lighting fixtures, such that would illuminate or mark a path or driveway.

2. Desciption of Prior Art

Existing landscape lighting devices are usually made out of plastic or aluminium and are vulnerable to being damaged or destroyed, usually by a vehicle driving over them. These devices must then be replaced at a considerable expense of time as well as cost.

### SUMMARY

A lighting apparatus that offers improved durability and survivability attributes. This device is intended to be tolerant of automotive vehicle run-overs in a driveway/landscape installation.

### BRIEF DESCRIPTIONS OF THE DRAWINGS

FIG. 1 shows the prefered embodiment of the invention staked into the ground.

FIG. 2 shows the prefered embodiment of the invention in the compromised position.

### DETAILED DESCRIPTION

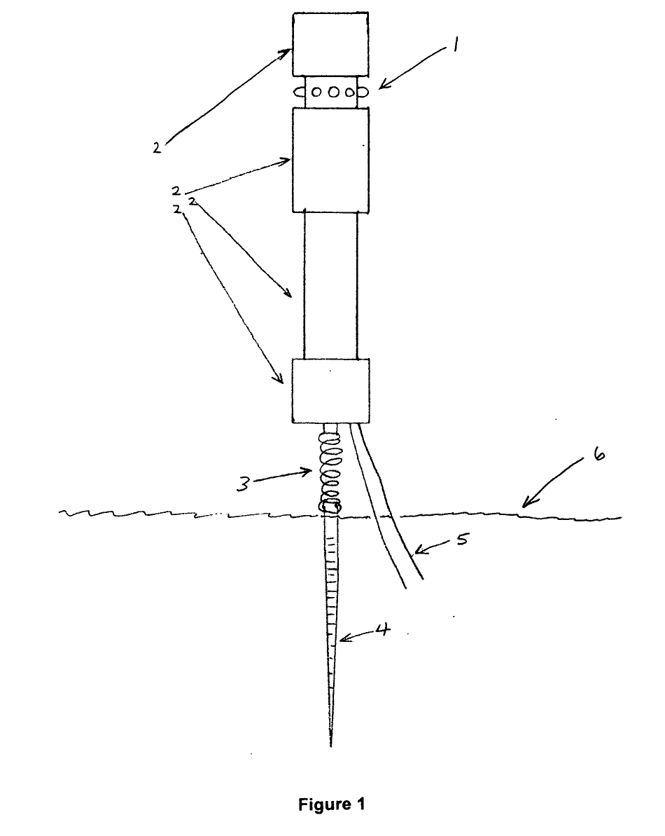

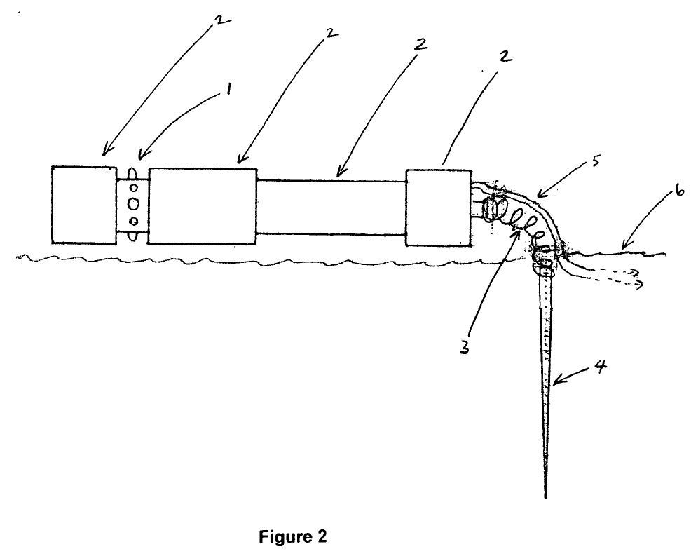

The prefered embodiment shown in FIGS. 1 and 2 consist of a light source 1, a body 2, a coupling 3, a stake or screw 4, power leads 5, and ground level 6. The body diameter of the device 2, is kept narrow to minimize contact area with a tire or other object rolling over the light. The base of the light is attached to a ground penetrating device 4, via a coupling 3. The coupling could be a flexible joint such as a spring, pivot, ball joint, or other flexible material. The light source 1, could be any type, but at the present LED's (Light Emitting Diodes) are the preffered choice, for cost, durability, and low power consumption. In the typical configuration, the LED's are placed around the circumference of the device near the top to project light in a horizontal pattern. They are recessed somewhat to provide protection when the light is in the compromised position.

Description—Alternate Embodiments

As an alternative to using a flexible coupling 3, an easily replaceable coupling, that would break free upon impact could be used. Also, as an alternate, the light source coud be a singular lens to condense/focus the light.

1. A lighting apparatus consisting of a light source attached to a vertical housing body.

2. A lighting apparatus consisting of a vertical housing body attached to a coupling.

3. A lighting apparatus consisting of a coupling securing apparatus to the ground.

4. A lighting apparatus consisting of a light source attached to a vertical housing structure with a flexible coupling at base of vertical structure.

5. A lighting apparatus consisting of a light source attached to a vertical housing structure with a break-free replaceable coupling at base of vertical structure.

6. An Electric lighting apparatus consisting of a solid state light emitting diode array attached to vertical structures of claims 4 and 5.

7. An Electric lighting apparatus, attached to vertical structures of claims 4 and 5, consisting of a dual array of solid state light emitting diodes with polarities reversed connected to allow different light output based on polarity connections.
